(19) United States
(12) Patent Application Publication
(10) Pub. No.: US 2007/0013107 A1
(43) Pub. Date: Jan. 18, 2007

(54) Epichlorohydrin rollers improved for grinding

(75) Inventor: William Hargis Barton, Nicholasville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/182,980

(22) Filed: Jul. 15, 2005

(51) Int. Cl. H05B 6/00

(52) U.S. Cl. 264/454; 29/895.32

(57) ABSTRACT

In manufacture of epichlorohydrin rollers, curing with heat is done in the absence of oxygen or with small amounts of an antioxidant mixture. Undesirable surface roughness does not occur. The rollers are then ground with only readily-removed dust resulting.

### TECHNICAL FIELD

This invention relates to rollers primarily used for imaging. More specifically, this invention relates to an improved composition of epichlorohydrin rollers for grinding with high yield.

### BACKGROUND OF THE INVENTION

Two types of eipchlorohydrin rollers used in conventional xerographic systems are charge rollers and developer rollers. As is widely practiced, the charge roller contacts a photoconductive roller or other photoconductive member to apply electric charge. Similarly, the developer roller carries toner from a toner supply source in a thin layer to a photoconductive roller or other photoconductive member. It is known that the main body of such rollers be epichlorohydrin rubber.

The manufacture of charge rollers and developer rollers involves molding epichlorohydrin rubber onto a metal shaft, thereby forming a so-called “molded core.” The molded core is subsequently subjected to an oven-baking process, which raises the electrical conductivity of the molded core to a specified level. The baked core is then ground to a precise diameter. The surface finish of the ground core is typically specified as 2 microns Ra, or less.

An undesirable side effect of the oven-baking process is an increase in the tackiness of the epichlorohydrin rubber material. This increased tackiness makes it more difficult to grind a smooth surface finish on the molded core. The increased tackiness also makes it more difficult to clean grinding dust off the ground core, since the dust tends to cling to the surface.

Rollers that do not achieve a smooth surface during grinding must be scrapped since they will not function correctly in the electrophotographic process. Likewise, rollers that are contaminated with sticky grinding dust must be scrapped, since they will not function correctly in the electrophotographic process. Therefore, there was a compelling economic motive to find a method to reduce the tackiness that occurs in the epichlorohydrin charge rollers and the epichlorohydrin developer rollers during the oven bake.

### DISCLOSURE OF THE INVENTION

This invention recognizes that the undesirable surface effects are the result of oxidation during the baking step. This was confirmed by baking in a nitrogen atmosphere. The undesirable surface effects did not occur. Although such denial of oxygen is an alternative, it has been found that a small amount of antioxidant in rubber formula of the previous rollers will avoid the undesirable effects.

Accordingly, a very high yield of useful rollers is achieved without scraping the rollers or the like after grinding.

### DESCRIPTION OF THE PREFERRED EMBODIMENTS

A representative roller modified in accordance with this invention is described in U.S. Pat. No. 6,072,970 to Barton et al. (Mr. Barton is the same person who is the inventor of this invention). The epichlorohydrin roller described in detail in that patent has more than 90 percent by weight epichlorohydrin as the body material. A mixture of two epichlorohydrins is used to select the resistivity and compression-set resistance. The epichlorohydrin rubbers used are random terpolymers of epichlorohydrin, ethylene oxide, and allyl glycidyl ether. Higher ethylene oxide will make the terpolymer rubber more conductive and higher allyl glycidyl ether will make the polymer more compression-set-resistant.

In that embodiment the formula to be molded and baked also includes small amounts of activator, lubricant accelerator, and crosslinker. The formula is thoroughly blended. The formula is molded in cylindrical form around a steel shaft in a heated press and cured in the mold for approximately 15 minutes at 320F to produce a rubber roller. The grinding step is by grit rollers or other mechanical abrasion, as may be entirely conventional, to obtain a circular circumference to a high degree of precision.

Although the foregoing patent describes a charge roller, it is illustrative of any epichlorohydrin roller, such as charge rollers, with which this invention may be practiced. Although the preferred epichlorohydrin formula is about 90 percent by weight epichlorohydrin, this invention is believed applicable to any such formula having a major part epichlorohydrin, such as 50 percent or more by weight of the formula.

Two different antioxidants were tested and found to be effective to substantially hinder oxidation of both the charge roller and the developer roller during the oven bake. These two antioxidants are NAUGARD 445, the chemical name of which is 4,4′-bis(α,α-dimethylbenzyl)diphenylamine; and OCTAMINE, the chemical name of which is octylated diphenylamine. Both these antioxidants are available from Uniroyal Chemical.

OCTAMINE is the preferred choice since it has a lower melt temperature than NAUGARD 445 (78-85° C. versus 98-100° C.), and hence OCTAMINE will more readily melt into the rubber during the rubber mixing operation. In both cases, for NAUGARD 445 and for OCTAMINE, the antioxidant is added into the rubber formula at a level of one part antioxidant per one hundred parts rubber hydrocarbon, by weight.

Developer rollers with added antioxidant could easily be ground to a smooth surface after oven bake, without sticky grinding dust.

What is claimed is:

1. A method of making a roller comprising
molding said roller from a mixture which cures under heat comprising epichlorohydrin in major part by weight, and
curing said molded mixture in the absence of oxygen.

2. A method of claim 1 in which said epichlorohydrin is about 90 percent by weight of said mixture.

3. A method of claim 1 also comprising grinding said cured mixture.

4. A method of claim 2 also comprising grinding said cured mixture.

5. A method of making a roller comprising
molding said roller from a mixture, which cures under heat comprising epichlorohydrin in major part by weight and having an antioxidant in about 1 part by weight to 100 parts by weight of said epichlorohydrin.

6. A method of claim 5 also comprising grinding said cured mixture.

7. A method of claim 5 in which said antioxidant is 4,4′-bis(α,α-dimethylbenzyl)diphenylamine.

8. A method of claim 7 also comprising grinding said cured mixture.

9. A method of claim 5 in which said antioxidant is octylated diphenylamine

10. A method of claim 9 also comprising grinding said cured mixture.

11. A method as in claim 5 in which said epichlorohydrin is about 90 percent by weight of the weight of said mixture.

12. A method as in claim 6 in which said epichlorohydrin is about 90 percent by weight of the weight of said mixture.

13. A method as in claim 7 in which said epichlorohydrin is about 90 percent by weight of the weight of said mixture.

14. A method as in claim 8 in which said epichlorohydrin is about 90 percent by weight of the weight of said mixture.

15. A method as in claim 9 in which said epichlorohydrin is about 90 percent by weight of the weight of said mixture.

16. A method as in claim 10 in which said epichlorohydrin is about 90 percent by weight of the weight of said mixture.
